(19) United States
(12) Patent Application Publication
(10) Pub. No.: US 2008/0092037 A1
(43) Pub. Date: Apr. 17, 2008

(54) Validation of XML content in a streaming fashion

(75) Inventors: Vijay Medi, Sunnyvale, CA (US); Sam Idicula, San Jose, CA (US); Sivasankaran Chandrasekar, Palo Alto, CA (US); Nipun Agarwal, Santa Clara, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: Oracle International Corporation, Redwood Shores, CA (US)

(21) Appl. No.: 11/729,943

(22) Filed: Mar. 28, 2007

Related U.S. Application Data
(60) Provisional application No. 60/829,652, filed on Oct. 16, 2006.

(51) Int. Cl. G06F 17/00; G06F 7/00

(52) U.S. Cl. 715/237; 707/102; 715/234; 707/100

(57) ABSTRACT

A method and apparatus for validating XML documents in a streaming fashion is provided. A streaming validator validates an XML document by comparing the contents of the XML document to an XML schema. Tokens are generated for each element or attribute of the XML schema and for each element or attribute of the XML document using the same generator token function. The elements and attributes of the XML document and XML schema are compared using tokens rather than string comparisons to perform the validation more efficiently.

### CROSS REFERENCE TO RELATED APPLICATION

This application claims the benefit of priority to U.S. Provisional Patent Application No. 60/829,652 filed on Oct. 16, 2006, entitled “ENHANCEMENTS FOR PROCESSING XML DATA” which is incorporated by reference in its entirety for all purposes as if originally set forth herein.

This application is related to U.S. patent application Ser. No. 11/407,508 filed on Apr. 19, 2006, entitled “STREAMING VALIDATION OF XML DOCUMENTS” which is incorporated by reference in its entirety for all purposes as if originally set forth herein.

### FIELD OF THE INVENTION

The present invention relates to managing XML content within a database, and more specifically to validating XML schemas with that XML content.

### BACKGROUND

The Extensible Markup Language (XML) is the standard for data and documents that is finding wide acceptance in the computer industry. XML describes and provides structure to a body of data, such as a file or data packet, referred to herein as an XML entity. The XML standard provides for tags that delimit sections of an XML entity referred to as XML elements. Each XML element may contain one or more name-value pairs referred to as attributes.

By defining an element that contains attributes and descendant elements, the XML entity defines a hierarchical tree relationship between the element, its descendant elements, and its attribute. A set of elements that have such a hierarchical tree relationship is referred to herein as an XML document.

XML Schema is a definition language that provides facilities for describing structure and constraining the contents of an XML document. A draft specification, referred to hereinafter as “XML Schema Specification”, for the XML Schema definition language is described in a set of three documents published by the W3C Consortium. The first document in the set is “XML Schema Part 0: Primer Second Edition”, W3C Recommendation 28 Oct. 2004, located at “http://www.w3.org/TR/xmlschema-0/”, the entire contents of which are hereby incorporated by reference for all purposes as if fully set forth herein. The second document in the set is “XML Schema Part 1: Structures Second Edition”, W3C Recommendation 28 Oct. 2004, located at “http://www.w3.org/TR/xmlschema-1/”, the entire contents of which are hereby incorporated by reference for all purposes as if fully set forth herein. The third document in the set is “XML Schema Part 2: Datatypes Second Edition”, W3C Recommendation 28 Oct. 2004, located at “http://www.w3.org/TR/xmlschema-2/”, the entire contents of which are hereby incorporated by reference for all purposes as if fully set forth herein.

As referred to herein, an XML schema is a defined structure for XML documents. An XML schema representation is data that describes the XML structure. An XML schema representation may include an XML document with declarations and/or a tokenized XML representation which is one for which tokens have been generated. An example of an XML schema representation includes, but is not limited to, an XML document with type definitions, element declarations, or attribute declarations.

XML schema representations are typically used for validation of XML documents. As used herein, validation refers to the process of determining whether a portion of an XML document (such as, for example, an entire XML document, an XML element included in an XML document, a sub-element of an XML element, or an attribute of an XML element) conforms to the definition and constraints specified in the relevant portion of an XML schema representation. The validation of a specific portion of an XML document may return a validation result which, depending on the particular implementation, may comprise one or more values that indicate a successful or a failed validation outcome. In addition, the validation result may also comprise an overall validation outcome for a particular portion of an XML document that includes one or more sub-portions (e.g. for an XML element that includes sub-elements.)

For various reasons, the validation process of an XML document against an XML schema representation requires numerous lookups involving string comparisons. The cumulative effect of these comparisons and the resulting overhead potentially affects the performance of the validation process and the overall system. Clearly, there is a need to perform the XML validation process in a more efficient way that avoids this sort of overhead.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates a high level overview of a method for streaming validation of XML documents;

FIG. 2 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are approaches to efficiently validate an XML document against an XML schema representation without performing the numerous string comparisons that may lead to system performance degradation.

### Method for Streaming Validation of XML Documents

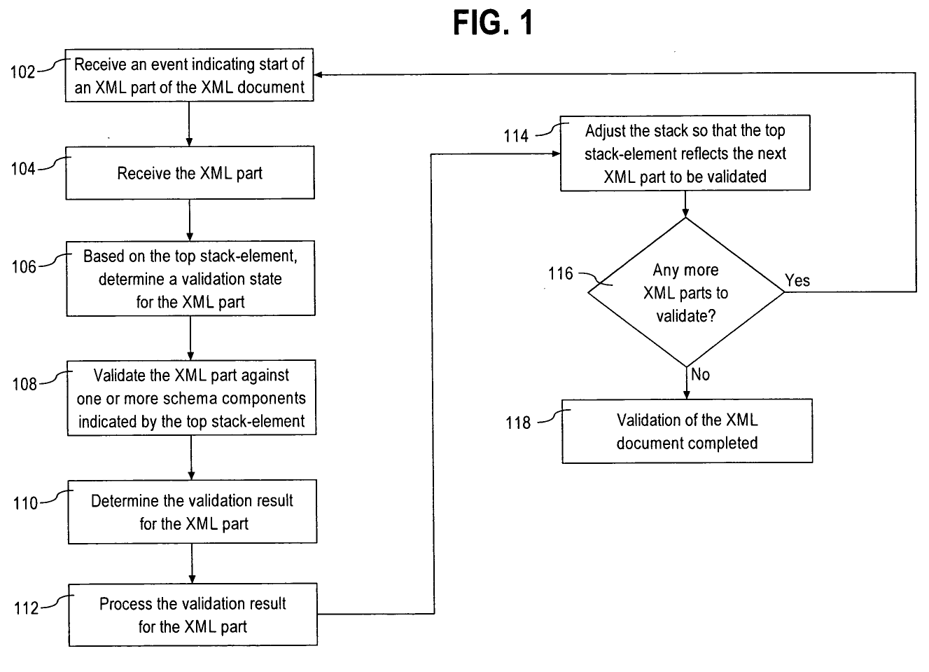

As recited in “Streaming Validation of XML Documents”, incorporated herein by reference, a technique is described for validating XML documents via streaming. FIG. 1 is a flow diagram that illustrates a high level overview of streaming validation of XML documents. In this technique, a streaming validator is invoked to validate a particular XML document against a specified XML schema representation. As used herein, a streaming validator is a software and/or hardware component included in a computer system that is capable of validating an XML document part by part, where a particular part of an XML document is validated based on information maintained by the streaming validator

In step 102, the streaming validator receives an event, which event indicates the start of an XML part of the XML document being validated. For example, the streaming validator may receive, from a parser that parses the XML document, a start_element event which indicates that the parser has encountered an XML element.

In step 104, the streaming validator receives the XML part from the parser. Receiving the XML part from the parser may include receiving the content of the XML part as well as receiving one or more additional events. For example, if the XML part is an XML element having simple XML type, the streaming validator may receive from the parser a characters event, followed by the content of that XML element as a stream of characters, and followed by an end_element event which indicates that the parsing of that XML element is complete. The content of the XML element may also be an empty content. In the case of an empty content, the streaming validator determines whether the schema defines default values for the content. If the schema defines a default value, then the streaming validator generates the events for that value.

In step 106, the streaming validator determines a current validation state for the received XML part based on the top, or current, stack-element that is stored in a stack maintained by the streaming validator. The current validation state indicates the validation type of the received XML part. The top stack-element includes values (e.g. pointers) that reference one or more portions of the XML schema representation against which the XML document is being validated. The one or more portions of the XML schema representation include the definition of the received XML part.

In step 108, the streaming validator validates the received XML part against the definition of the part included in the portion of the XML schema representation that is indicated in the top stack-element. Depending on the validation type of the XML part (as reflected by the current validation state indicated by the top stack-element), the streaming validator may dispatch the XML part for validation to one of its modules that is configured to validate XML parts having that particular validation type. During the process of validation, the module validating the received XML part may store or remove stack-elements from the stack as necessary to track the progress of the validation against the XML schema representation. After the module completes the validation of the received XML part, the module generates a validation result for that part.

In step 110, the streaming validator determines the validation result for the received XML part. For example, the streaming validator may receive the validation result from the module which completed the validation of that part. In step 112, the streaming validator processes the validation result. For example, if the streaming validator is operating in pipeline mode, the streaming validator may augment the validation result to one or more events (which are associated with the just validated XML part and are received from an events producer that is positioned in front of the streaming validator in the pipeline), and may send these augmented events to an events consumer that is positioned behind the streaming validator in the pipeline. If the streaming validator is operating in standalone mode, the streaming validator may record, or otherwise store, the validation result for the just validated XML part. In addition, regardless of the mode in which it operates, the streaming validator may store the validation result for the received XML part in a log, which is associated with the XML document being validated and includes information indicating the progress of the validation.

After processing the validation result for the XML part in step 112, in step 114 the streaming validator adjusts the stack so that the top stack-element reflects the next XML part that is to be validated. Adjusting the stack may include removing one or more stack-elements from the stack and/or storing one or more stack-elements on the stack. After adjusting the stack is completed, the top stack-element reflects the validation state of the next XML part that is to be received, and includes values which indicate one or more portions of the XML schema representation that include the definition of that next XML part.

After the stack is adjusted in step 114, in step 116 the streaming validator determines whether there are any more XML parts of the XML document that need to be validated. For example, based on information stored in the top stack-element, the streaming validator may check the XML schema representation to determine whether the XML document may include any more XML parts. In another example, in this step the streaming validator may receive one or more events from a parser, which one or more events do not indicate that parts of the XML document that are to be received next need any validation (e.g. comments events). If the streaming validator determines that there are more XML parts to be validated, the streaming validator proceeds with step 102. If the streaming validator determines that there are no more XML parts to validate (e.g. streaming validator receives an end-document event), then the streaming validator proceeds with step 118.

In step 118 the validation of the XML document against the XML schema representation is completed. In this step, if the streaming validator operates in standalone mode, the streaming validator may generate an overall validation result for the entire XML document based on the stored validation results for each validated XML part of the XML document. The streaming validator may then send the overall validation result to the application which requested the validation of the XML document in the first place.

### Token Based Validation Mechanism

The streaming validator validates the XML document by comparing the contents of the XML document to an XML schema representation. As mentioned previously, the XML schema representation is data that describes an XML schema. An XML schema representation may include an XML document with declarations or a tokenized XML representation which is one for which tokens have been generated. One method to perform the comparisons are through string comparisons. When an XML document is parsed, a parser generates strings of each element in the XML document. The strings are then sent to the streaming validator which performs validations by comparing the XML document strings to the strings in the corresponding portion of the XML schema representation. These string comparisons are very expensive because, in order to be considered equal, each character in each string of the XML document is matched exactly to each character in each string of the XML schema representation. In the context of a single string comparison, the processing required is small. However, XML documents may be extremely large and multiple string comparisons are often performed for each validation, which makes this method extremely expensive.

In an embodiment of the invention, a token based validation mechanism is used. Rather than the parser passing strings of the XML document, the parser instead passes a token to the streaming validator. As used herein, a token is a unique series of bits used to indicate a string that is generated by a token generator. Based upon the parameters of the token generator, strings are converted into a token with each unique string given a unique token. The size of the tokens may vary and can include, but is not limited to, four bytes, eight bytes, or sixteen bytes. Comparing tokens is far more efficient than comparing characters in a string, because the token is compared in a single action. For example, examine the strings “forget” and “forgot”. In a string comparison, six separate characters are compared with this string and the only difference between the strings is the fifth letter. Now examine the comparison if the strings were converted to a token, “forget”=tok1 and “forgot”=tok2. Now the validator would quickly determine after a single comparison that tok1 !=tok2 because comparing tokens is computationally the same process as comparing integers.

In an embodiment, tokens are generated with the parser and not with the streaming validator. Thus the parser, rather than generating strings of each element of the XML document, generates a token for each element. In another embodiment, the parser and the streaming validator are part of a single component and so tokens are generated by the component. In order to determine which element is to be compared, the streaming validator maintains a token table that maps the element, attribute names, and namespace uniform resource identifiers (URIs) into tokens.

In an embodiment, the schema load component and the parser are modified to allow token validation. The schema load component is the component in the database management system which loads the XML schema representation and generates an internal representation of the XML schema. The streaming validator parses the XML schema representation and associates 4-byte tokens for each unique item defined in the XML schema representation. The unique items in the XML schema representation include, but are not limited to, element names, attribute names, and namespace URIs.

In an embodiment, the parser is initiated after loading the XML schema representation. The streaming validator creates a pull-based events context to begin parsing the XML document. The parser generates 4-byte tokens using the same token-generator function as used with the schema load component. Tokens are generated for the element names, attribute names, and namespace URI's in the XML document. The parser also maintains a prefix-to-token table for mapping a given prefix to a token representing the corresponding namespace URI. As used herein, a prefix provides the namespace part of the qualified name in an XML document, and is associated with a namespace URI reference in a namespace declaration.

Once the XML schema representation has been loaded with all the necessary associated tokens, the streaming validator validates the XML document by fetching the tokens associated with each event and performing token-based comparisons. The token-based comparisons make the validation process much more efficient.

### The Validation Process

One aspect of validating an XML document is identifying the element definition on a start_element event. The start_element event is the part of the XML document which indicates that an element begins. In an embodiment, when the streaming validator receives the start_element event, the streaming validator identifies the element in the set of schema components. The identification is made using the localname, prefix and the namespace URI. The prefix and the associated namespace URI are used to identify the target namespace that contains the XML schema definition of the element. For example, XML schema representations might contain identical items, but be in different namespaces.

```
Schema 1:
<Namespace 1>
  <Item>
    <Size>
  <Address>
Schema 2:
<Namespace 2>
  <Item>
    <id>
    <Color>
XML Document:
<Item id =”10” xsi:type=”Namespace 2:Item”>
  <Color>Red</Color>
</Item>
```

In the example, both Schema 1 and Schema 2 contain an element named “Item”. But Schema 2, under Namespace 2, also contains the elements “id” and “Color” under “Item”. If the streaming validator identifies an “Item”, the streaming validator needs to know the namespace to correctly identify the schema to perform the validation. Thus under these circumstances, the XML document would provide the prefix and namespace URI in order to determine if the schema under “Namespace 1” or “Namespace 2” is to be used. The XML document under this example identified Namespace 2. After identifying the target namespace, the localname is used to get the actual element definition. In this example, the localname would be “Item”.

Thus, the start_element event process involves two different string comparisons. The first is to identify the target namespace. The second is to identify the element definition. By using token-based validation, two string comparisons can be eliminated in this single process.

Once an element definition has been identified, the attributes of the element are processed. XML attributes are name-value pairs included in the start tag after the element name. For example, in the XML document above, id=“10” is the attribute of element “Item”. Since the attribute list of an element does not have an order, there are two iterations of the attributes. The first iteration is to identify certain pre-defined attributes and the second iteration to identify non-predefined attributes. Predefined attributes include, but are not limited to, xsi:type, xsi:schemaLocation, and xsi:noNamespaceSchemaLocation. “xsi:type” indicates a reference to the type of value stored. This may include simple or complex types. “xsi:schemaLocation” and “xsi:noNamespaceSchemaLocation” indicate the physical location of the of schema representation that may used for assessment.

Predefined attributes involve at least one string-based comparison. If a pre-defined attribute is present, more than two string comparisons are performed to identify the value of the pre-defined attribute. In the second iteration over the attribute list, other attributes are processed. Two string comparisons are used to identify the attribute type definition and this occurs for each attribute of each element. Thus considerable savings are found when token-based validation is employed.

In processing the end_element event, only one string based comparison is performed. The end_element indicates the end of the particular element. In the example above for the XML document, </Item> marks the end_element for the element “Item.” Only one string comparison is needed to identify the element. Thus, this validation process would also benefit by transferring to token-based validation.

Other validation processes also use string comparisons in order to validate XML documents. These include, but are not exclusively, substitution groups, wildcards, and identity constraints.

In substitution groups, other elements may be substituted for an element. For example, an XML schema representation may provide:

<xsd:element name =”foo” substitutionGroup=”Root”>
</xsd:element>

In this example, the element “foo” might be substituted by any of the objects identified by “Root”. Assume “Root” identifies foo, foo2, and foo3 as substitutions. Thus if an XML document identifies “foo2”, then the definition also validates the XML document. Substitution groups requires additional string comparisons in order to identify the different objects that may be used as substitutes.

Wildcards provide for validation of attribute and element information items dependent on their namespace name, but independently of their local name. “xs:any” and “xs:anyAttribute” are used to allow the occurrence of elements and attributes from specified namespaces. Identity constraints in an XML schema representation assert that the values identified by a certain element are unique. For example, identification numbers are often required to be unique for each separate transaction. Each of these validations require string comparisons to identify the component and understand any further restrictions. Thus each of the validation processes would benefit by employing a token-based validation mechanism.

### Hardware Overview

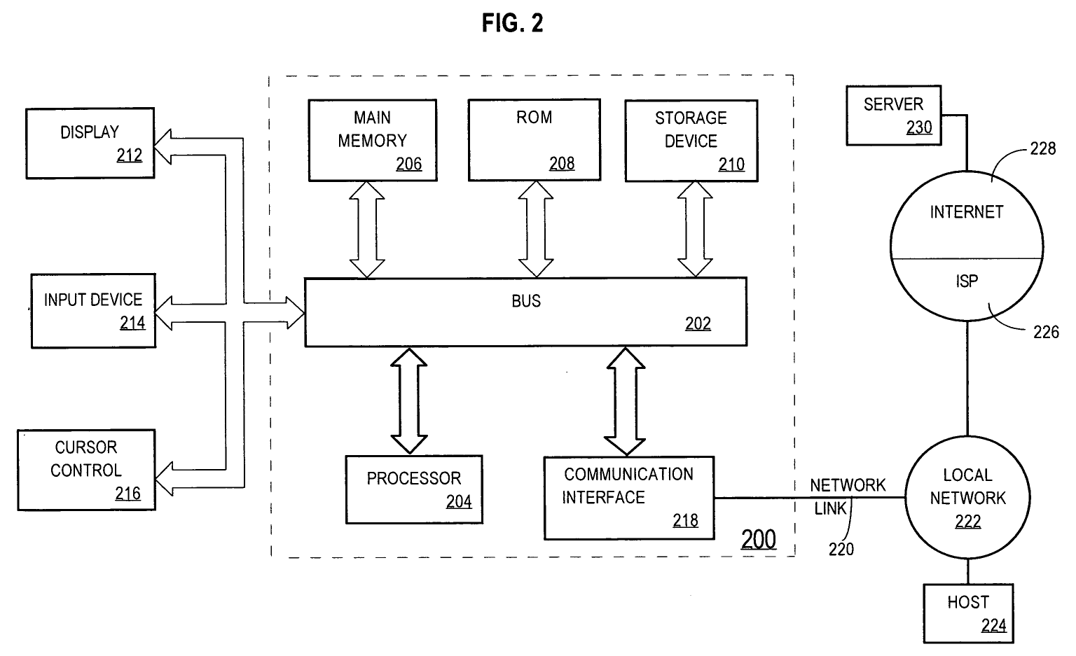

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method to validate XML content in an XML document stored in a database, the method comprising the steps of:
reading at least a portion of a XML schema representation of an XML schema, where the representation associates a plurality of tokens with said XML schema, wherein for each item of a set of items declared for said XML schema, the XML schema representation associates a particular token from said plurality of tokens with said each item;
validating said XML document, wherein validating includes:
generating tokens for elements and attributes in said XML document; and
performing comparisons of said tokens generated from the XML document with said plurality of tokens of the XML schema representation.

2. The method of claim 1, wherein each item of a set of items declared in said XML schema includes a namespace URI.

3. The method of claim 2, wherein a table is maintained mapping a prefix to a token to said namespace URI.

4. The method of claim 1, wherein generating tokens for elements and attributes in said XML document includes generating tokens for a start_element event from the XML document.

5. The method of claim 1, wherein generating tokens for elements and attributes in said XML document includes generating tokens for an end_element event from the XML document.

6. The method of claim 1, wherein generating tokens for elements and attributes in said XML document includes generating tokens of pre-defined attributes in the XML document.

7. The method of claim 1, wherein each item of a set of items declared in said XML schema includes substitution groups.

8. The method of claim 1, wherein each item of a set of items declared in said XML schema includes identity constraints.

9. The method of claim 1, wherein each item of a set of items declared in said XML schema includes wildcards.

10. The method of claim 1, wherein said tokens generated from the XML document and said tokens generated from the XML schema are 4-bytes in size.

11. The method of claim 1, wherein generating tokens for each item of a set of items declared in said XML schema is performed by a streaming validator.

12. The method of claim 1, wherein generating tokens for elements and attributes in said XML document is performed by a parser.

13. A computer-readable storage medium carrying one or more sequences of instructions which, when executed by one or more processors, causes the one or more processors to perform the method recited in claim 1.

14. A computer-readable storage medium carrying one or more sequences of instructions which, when executed by one or more processors, causes the one or more processors to perform the method recited in claim 2.

15. A computer-readable storage medium carrying one or more sequences of instructions which, when executed by one or more processors, causes the one or more processors to perform the method recited in claim 3.

16. A computer-readable storage medium carrying one or more sequences of instructions which, when executed by one or more processors, causes the one or more processors to perform the method recited in claim 4.

17. A computer-readable storage medium carrying one or more sequences of instructions which, when executed by one or more processors, causes the one or more processors to perform the method recited in claim 5.

18. A computer-readable storage medium carrying one or more sequences of instructions which, when executed by one or more processors, causes the one or more processors to perform the method recited in claim 6.

19. A computer-readable storage medium carrying one or more sequences of instructions which, when executed by one or more processors, causes the one or more processors to perform the method recited in claim 7.

20. A computer-readable storage medium carrying one or more sequences of instructions which, when executed by one or more processors, causes the one or more processors to perform the method recited in claim 8.

21. A computer-readable storage medium carrying one or more sequences of instructions which, when executed by one or more processors, causes the one or more processors to perform the method recited in claim 9.

22. A computer-readable storage medium carrying one or more sequences of instructions which, when executed by one or more processors, causes the one or more processors to perform the method recited in claim 10.

23. A computer-readable storage medium carrying one or more sequences of instructions which, when executed by one or more processors, causes the one or more processors to perform the method recited in claim 11.

24. A computer-readable storage medium carrying one or more sequences of instructions which, when executed by one or more processors, causes the one or more processors to perform the method recited in claim 12.
